(19) United States
(12) Patent Application Publication
(10) Pub. No.: US 2017/0054765 A1
(43) Pub. Date: Feb. 23, 2017

(54) SYSTEMS AND METHODS FOR ESTABLISHING A CONTROL CHANNEL BETWEEN A VIRTUALIZATION SERVER AND A CLIENT DEVICE

(71) Applicant: Five9, Inc., San Ramon, CA (US)

(72) Inventors: Douglas P. Tucker, San Francisco, CA (US); Andrey Kovalenko, Portola Valley, CA (US)

(21) Appl. No.: 15/057,166

(22) Filed: Mar. 1, 2016

Related U.S. Application Data
(60) Provisional application No. 62/205,864, filed on Aug. 17, 2015.

(51) Int. Cl. H04L 29/06; G06F 9/455

(52) U.S. Cl. CPC H04L 65/1069; H04L 67/42; G06F 9/45558; G06F 2009/45595

(57) ABSTRACT

Systems and methods for establishing a control channel between a virtualization server and a client device are provided. A virtual desktop session is established between the virtualization server and the client, and the virtualization server executes a virtual desktop instance. The client device executes a first application that is configured to receive a control channel connection request from a second application running within the virtual desktop instance. The second application runs an algorithm to discover an Internet Protocol (IP) address of the client device being used to access the second application. Using the IP address, a control channel outside of the virtual desktop session is established between the first and second applications. Instructions are transmitted from the second application to the first application via the control channel, and the first application is controlled remotely by the second application based on the instructions.

### CROSS-REFERENCE TO RELATED APPLICATIONS

This disclosure claims priority to U.S. Provisional Patent Application No. 62/205,864, filed on Aug. 17, 2015, which is incorporated herein by reference in its entirety.

### TECHNICAL FIELD

The technology described in this document relates generally to desktop virtualization and more particularly to systems and methods for establishing a control channel between a virtualization server and a client device.

### BACKGROUND

Desktop virtualization enables a user's computing environment (e.g., operating system, applications, etc.) to be separated from the user's physical computing device (e.g., smartphone, laptop, desktop computer, etc.). Thus, a virtual desktop may be presented by a virtualization server that is remote from a client device, and applications may be executed within the virtual desktop at the request of the client device. The client device is provided a view into the virtual desktop via an encrypted data channel between the client device and the virtualization server. Applications executed within the virtual desktop are installed and executed on the virtualization server, rather than on the local client device. Users' work product (e.g., files created via the applications) is generally stored on the virtualization server or another location that is remote from the users' client devices. Desktop virtualization provides a means of centrally controlling the configuration and information security of a distributed workstation environment, among other benefits.

### SUMMARY

The present disclosure is directed to systems and methods for establishing a control channel between a virtualization server and a client device. In an example computer-implemented method performed by a virtualization server for establishing a control channel between the virtualization server and a client device, a virtual desktop session with the client device is established via a network. A virtual desktop instance is executed, where the client device has executed a first application that is configured to receive a control channel connection request from a second application running within the virtual desktop instance. The second application is executed within the virtual desktop instance, where the second application runs an algorithm to discover an Internet Protocol (IP) address of the client device being used to access the second application. Using the IP address, a control channel connection request is transmitted to the first application. A control channel is established between the first and second applications based on the transmitted request. The control channel is outside of the virtual desktop session. Instructions are transmitted from the second application to the first application via the control channel, and the first application is controlled remotely by the second application based on the instructions.

An example virtualization server that is configured to establish a control channel between the virtualization server and a client device includes a processing system and a memory coupled to the processing system. The processing system is configured to execute steps. In executing the steps, a virtual desktop session with the client device is established via a network. A virtual desktop instance is executed, where the client device has executed a first application that is configured to receive a control channel connection request from a second application running within the virtual desktop instance. The second application is executed within the virtual desktop instance, where the second application runs an algorithm to discover an Internet Protocol (IP) address of the client device being used to access the second application. Using the IP address, a control channel connection request is transmitted to the first application. A control channel is established between the first and second applications based on the transmitted request. The control channel is outside of the virtual desktop session. Instructions are transmitted from the second application to the first application via the control channel, and the first application is controlled remotely by the second application based on the instructions.

An example non-transitory computer-readable storage medium for establishing a control channel between a virtualization server and a client device comprises computer executable instructions which, when executed, cause a processing system to execute steps. In executing the steps, a virtual desktop session with the client device is established via a network. A virtual desktop instance is executed, where the client device has executed a first application that is configured to receive a control channel connection request from a second application running within the virtual desktop instance. The second application is executed within the virtual desktop instance, where the second application runs an algorithm to discover an Internet Protocol (IP) address of the client device being used to access the second application. Using the IP address, a control channel connection request is transmitted to the first application. A control channel is established between the first and second applications based on the transmitted request. The control channel is outside of the virtual desktop session. Instructions are transmitted from the second application to the first application via the control channel, and the first application is controlled remotely by the second application based on the instructions.

In an example computer-implemented method performed by a client device for establishing a control channel between the client device and a virtualization server, a first application is executed, where the first application is configured to receive a control channel connection request from the virtualization server. A virtual desktop session is established with the virtualization server via a network, the virtualization server executing a virtual desktop instance. The virtualization server is instructed, via the virtual desktop session, to execute a second application within the virtual desktop instance. The second application is configured to (i) run an algorithm to discover an Internet Protocol (IP) address of the client device being used to access the second application, and (ii) transmit, using the IP address, a control channel connection request to the first application. The control channel connection request is received at the first application. A control channel is established between the first and second applications based on the received request, where the control channel is outside of the virtual desktop session. Instructions are received from the second application at the first application via the control channel, and the first application is controlled remotely by the second application based on the instructions.

An example client device configured to establish a control channel between the client device and a virtualization server includes a processing system and a memory coupled to the processing system. The processing system is configured to execute steps. In executing the steps, a first application is executed, where the first application is configured to receive a control channel connection request from the virtualization server. A virtual desktop session is established with the virtualization server via a network, the virtualization server executing a virtual desktop instance. The virtualization server is instructed, via the virtual desktop session, to execute a second application within the virtual desktop instance. The second application is configured to (i) run an algorithm to discover an Internet Protocol (IP) address of the client device being used to access the second application, and (ii) transmit, using the IP address, a control channel connection request to the first application. The control channel connection request is received at the first application. A control channel is established between the first and second applications based on the received request, where the control channel is outside of the virtual desktop session. Instructions are received from the second application at the first application via the control channel, and the first application is controlled remotely by the second application based on the instructions.

An example non-transitory computer-readable storage medium for establishing a control channel between a virtualization server and a client device comprises computer executable instructions which, when executed, cause a processing system to execute steps. In executing the steps, a first application is executed, where the first application is configured to receive a control channel connection request from the virtualization server. A virtual desktop session is established with the virtualization server via a network, the virtualization server executing a virtual desktop instance. The virtualization server is instructed, via the virtual desktop session, to execute a second application within the virtual desktop instance. The second application is configured to (i) run an algorithm to discover an Internet Protocol (IP) address of the client device being used to access the second application, and (ii) transmit, using the IP address, a control channel connection request to the first application. The control channel connection request is received at the first application. A control channel is established between the first and second applications based on the received request, where the control channel is outside of the virtual desktop session. Instructions are received from the second application at the first application via the control channel, and the first application is controlled remotely by the second application based on the instructions.

### BRIEF DESCRIPTION OF THE FIGURES

FIG. 1 is a block diagram depicting an example virtualization server and an example client device.

FIG. 2 depicts a virtual desktop session and control channel formed between a virtualization server and a client device.

FIG. 3 depicts example steps performed by a client device and a virtualization server for establishing a control channel between the virtualization server and the client device.

FIG. 4 depicts steps of an example algorithm performed by a second application to discover an IP address of a client device.

FIG. 5 illustrates example steps performed by a second application (i) to determine that it is running in a virtual desktop environment, and (ii) to determine the routing information necessary to connect the second application to the first application.

FIG. 6 depicts a control channel formed between an application executed on a virtualization server and a media application executed on a client device.

FIG. 7 depicts features of an example application executed on a virtualization server.

FIG. 8 depicts features of an example media application executed on a client device.

FIG. 9 is a flowchart depicting steps of an example computer-implemented method performed by a virtualization server for establishing a control channel between the virtualization server and a client device.

FIG. 10 is a flowchart depicting steps of an example computer-implemented method performed by a client device for establishing a control channel between the client device and a virtualization server.

### DETAILED DESCRIPTION

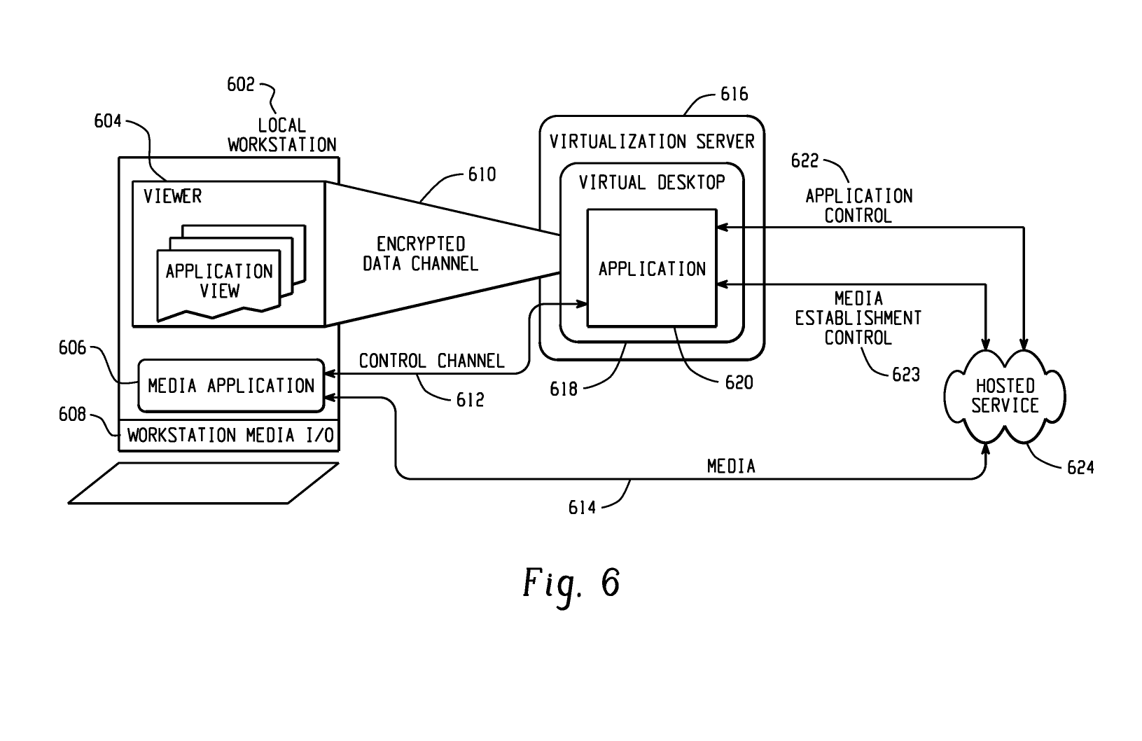

Desktop virtualization enables an operating system for a client device to be hosted within a virtual machine running on a virtualization server. To provide desktop virtualization services, a virtual desktop session is established between the virtualization server and the client device. The virtualization server presents a virtual desktop to the client device, and applications may be executed within the virtual desktop at the request of the client device. There are instances where it may be desirable to establish connectivity (e.g., a direct connection) between a first application that is executed on the client device and a second application that is executed on the virtualization server. For example, a media application may be executed on the client device, with the media application being configured to receive media streams from a remote server and to render media locally on the client device. Such media applications are described in further detail below, with reference to FIGS. 6-8. It may be desirable to enable an application executed on the virtualization server to connect directly to the media application, thus permitting the application on the virtualization server to control the media application remotely.

Conventionally, virtual desktop vendors (e.g., Citrix, VMWare, Microsoft, etc.) provide application programming interfaces (APIs) that may be used to establish connectivity between a first application executed on the client device and a second application executed within the virtual desktop on the virtualization server. Using such APIs, a channel connecting the applications may be formed within the virtual desktop session. Each virtual desktop vendor has its own proprietary mechanisms and controls access to this channel. Thus, for example, to establish such a channel in the context of a Citrix virtual desktop environment, an application must be configured, specifically, to work with Citrix's proprietary APIs. To establish the channel in the context of a VMWare virtual desktop environment, a different solution that is configured to work with VMWare's APIs would be required. In these conventional solutions, application providers are forced to create multiple solutions, one for each virtual desktop platform with which they wish to work.

In contrast to these conventional solutions, the approaches described herein enable the establishment of a control channel between first and second applications executed on the client device and virtualization server, respectively, without the use of vendor-specific APIs. The approaches described herein are thus configured to operate with all virtual desktop solutions and are not specific to any virtual desktop vendor or virtual desktop type. The control channel described herein is outside of the virtual desktop session and enables the second application executed on the virtualization server to remotely control the first application executed on the client device. In examples described herein, the control channel is used, specifically, to enable an application executed on the virtualization server to remotely control a media application executed on the client device. It is noted, however, that the scope of the disclosure is not limited to this example involving the media application.

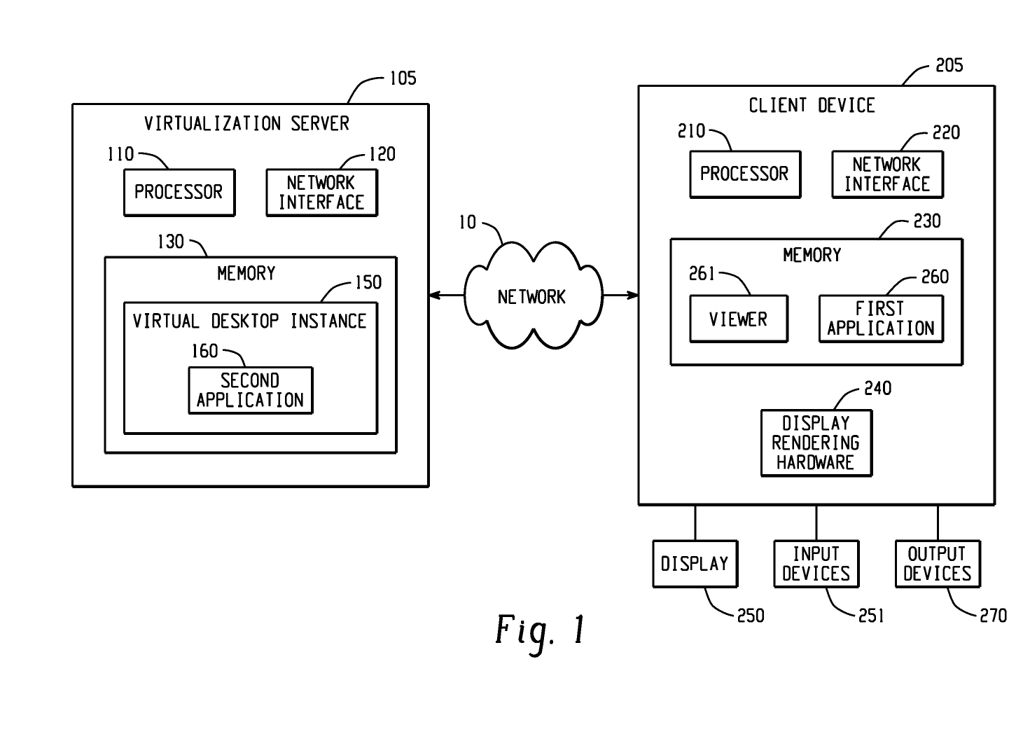

FIG. 1 is a block diagram depicting an example virtualization server 105 and an example client device 205. The virtualization server 105 and the client device 205 are connected via a network 10. Using the network 10, a virtual desktop session may be established between the virtualization server 105 and the client device 205. The network 10 represents any hardware and/or software configured to communicate information via any suitable communications media (e.g., WAN, LAN, Internet, Intranet, wired, wireless, etc.). In examples, the network 10 includes routers, hubs, switches, gateways, or other suitable components.

The virtualization server 105 includes a processing system 110, a network interface 120, and a memory 130, among other components. The processing system 110 is implemented via a microprocessor, microcontroller, system on a chip (SOC), or other fixed or programmable logic, in examples, and may include one or more processors or processor cores. The processing system 110 is configured to execute instructions stored in the memory 130 or in other memories of the virtualization server 105. The network interface 120 enables the virtualization server 105 to communicate with the client device 205 and/or other networked systems. The memory 130 includes read only memory (ROM), random access memory (RAM), erasable programmable read-only memory (EPROM), magnetic disk storage media devices, optical storage media devices, flash memory devices, electrical, optical, or other physical/tangible memory storage devices, in examples. The memory 130 may comprise a non-transitory computer readable storage medium having computer program instructions. Such instructions are executed by the processing system 110 to perform the operations described herein (e.g., operations for discovering an Internet Protocol (IP) address of the client device 205, among others).

In examples, a virtual desktop instance 150 is executed in the memory 130. When a virtual desktop session is established between the virtualization server 105 and the client device 205, the virtualization server 105 presents the virtual desktop instance 150 to the client device 205, and applications are executed within the virtual desktop instance 150 at the request of the client device 205. An example of such an application executed within the virtual desktop instance 150 at the request of the client device 205 is a second application 160 depicted in FIG. 1. The second application 160 is configured to perform operations (e.g., execute algorithms) for establishing a control channel that is outside of the virtual desktop session. Additional description of the second application 160 and the control channel is included throughout this disclosure.

In the example of FIG. 1, the client device 205 includes a processing system 210, a network interface 220, a memory 230, and display rendering hardware 240. The processing system 210 is configured to execute instructions stored in the memory 230 or in other memories of the client device 205. The network interface 220 enables the client device 205 to communicate with the virtualization server 105 and/or other networked systems. The memory 230 includes ROM, RAM, EPROM, magnetic disk storage media devices, optical storage media devices, flash memory devices, electrical, optical, or other physical/tangible memory storage devices, in examples. The memory 230 may comprise a non-transitory computer readable storage medium having computer program instructions. Such instructions are executed by the processing system 210 to perform the operations described herein (e.g., operations for establishing a media channel between the client device 205 and a remote computing system, among others).

In examples, one or more applications are executed in the memory 230. The one or more applications include a viewer application 261. The viewer application 261 enables the client device 205 to interact with the virtual desktop instance 150 and execute applications within the virtual desktop instance 150, such as the second application 160. Additionally, a first application 260 is executed in the memory 230. The first application 260 is configured to perform operations (e.g., execute algorithms) for establishing the control channel that is outside of the virtual desktop session. For example, the first application 260 is configured to receive a control channel connection request from the virtualization server 105 and complete a negotiation to establish the control channel. Additional description of the first application 260 and the control channel is included throughout this disclosure. The “media application” described herein is an example of the first application 260 and is described in greater detail below.

The display rendering hardware 240 may be a part of the processor 210 or may be a separate graphics processor (e.g., a graphics processing unit (GPU)). The client device 205 interfaces with a display device 250 (e.g., computer monitor, screen of a tablet computer or smartphone, etc.), one or more input devices 260 (e.g., keyboard, mouse, touchscreen, etc.), and one or more output devices 270 (e.g., speakers, etc.).

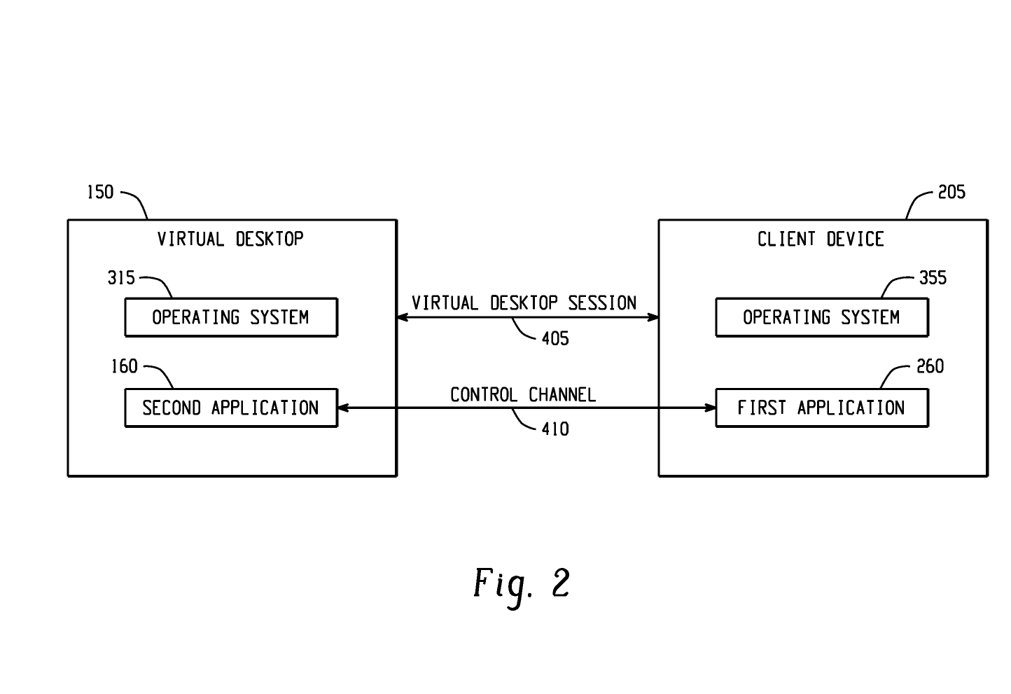

As described above, it may be desirable to enable an application executed on the virtualization server 105 to connect directly to an application executed locally on the client device 205, thus permitting the application on the virtualization server 105 to control the application on the client device 205 remotely. For example, it may be desirable to establish a direct control channel between the first application 260 and the second application 160, thus enabling the second application 160 to control the first application 260 remotely. Details on the establishment of such a control channel are described with reference to FIG. 2. This figure shows a virtual desktop session 405 formed between the virtual desktop instance 150 and the client device 205. The virtual desktop instance 150 includes an operating system 315 and the second application 160, among other applications, all of which are executed in the memory 130. The client device 205 includes an operating system 355 and the first application 260, among other applications, all of which are executed in the memory 230.

The operating system 315 provides virtual desktop interface functionality to the client device 205 over the virtual desktop session 405. The virtual desktop session 405 is established via a suitable virtual desktop protocol (e.g., Citrix Independent Computing Architecture (ICA), VMWare PC over IP (PCoIP), Microsoft Remote Desktop Protocol (RDP), etc.). In examples, the host operating system 315 sends virtual desktop display information to the client device 205 via the virtual desktop session 405, and the client device 205 renders the virtual desktop display information as an image that can be seen by a user of the client device 205. The virtual desktop session 405 is also used to transmit user inputs (e.g., inputs from input devices 260 of the client device 205) from the client device 205 to the operating system 315.

FIG. 2 also shows a control channel 410 formed between the first application 260 and the second application 160. The control channel 410 is outside of the virtual desktop session 405 and enables the second application 160 to control the first application 260 remotely. Specifically, the second application 160 transmits instructions to the first application 260 via the control channel 410, and the first application 260 is thus controlled remotely by the second application 160 based on the instructions. In examples, to establish the control channel 410, the second application 160 executes an algorithm to discover an Internet Protocol (IP) address of the client device 205. Using the discovered IP address, the second application 160 transmits a control channel connection request to the first application 260, thus facilitating the establishment of the control channel 410.

It is noted that the control channel 410 is established without the use of vendor-specific APIs. The approaches described herein for establishing the control channel 410 are thus configured to operate with all virtual desktop solutions and are not specific to any virtual desktop vendor or virtual desktop type. As noted above, in establishing the control channel 410, the second application 160 executes an algorithm to discover the IP address of the client device 205. In examples, the algorithm is configured to discover the IP address of the client device 205 based on one or more services of the operating system 315. Such services may include the operating system's process list, registry, installed application support directory, and network connection table, among others. The use of such operating system services in determining the client device's IP address is described in further detail below.

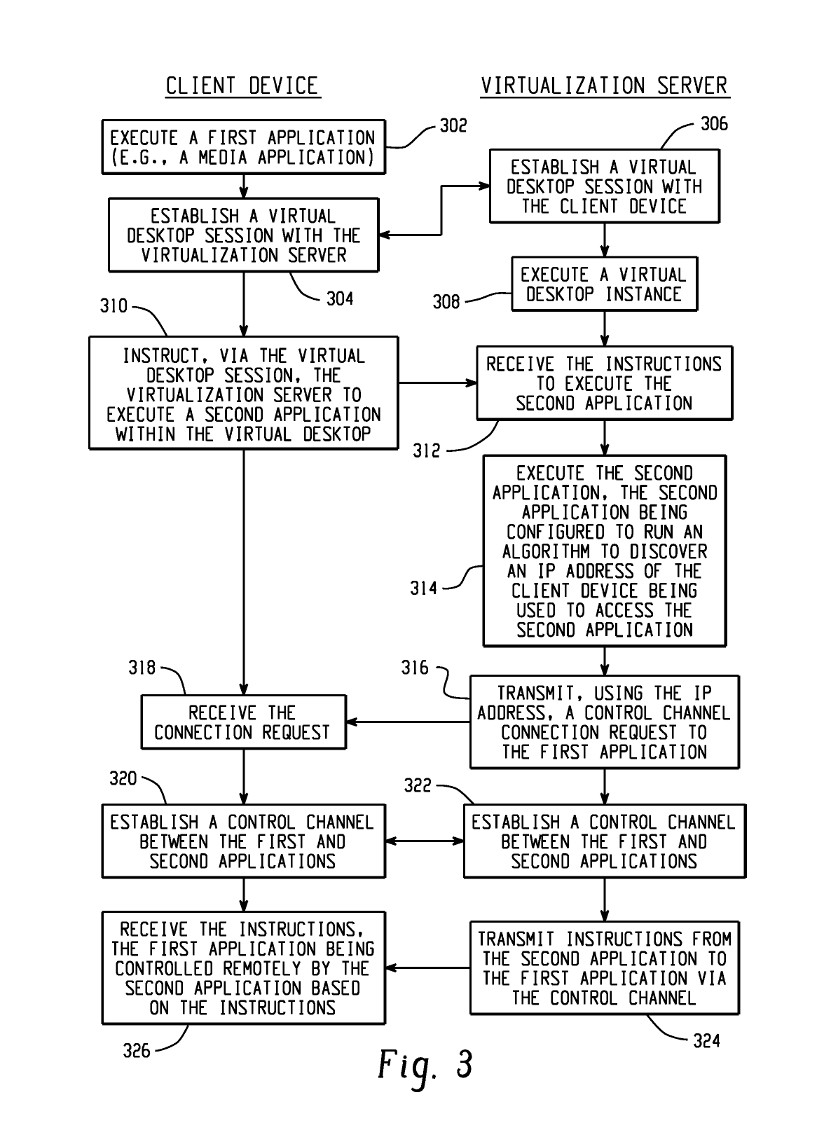

In an example, the control channel 410 between the first application 260 and the second application 160 is established based on steps performed at both the client device 205 and the virtualization server 105. To illustrate this, reference is made to FIG. 3. In this example, the steps begin at the client device, with the client device executing a first application. In examples, the first application is a media application, as described in greater detail below. At 304 and 306, respectively, the client device and the virtualization server perform steps to establish a virtual desktop session between the two devices. Such steps for establishing the virtual desktop session are conventional and are known to those of ordinary skill in the art. At 306, the virtualization server executes a virtual desktop instance. The client device interacts with the virtual desktop instance via the virtual desktop session, as described above.

At 310, the client device instructs, via the virtual desktop session, the virtualization server to execute a second application within the virtual desktop instance. At 312, the virtualization server receives the instructions from the client device to execute the second application. At 314, the virtualization server executes the second application, with the second application being configured to run an algorithm to discover the IP address of the client device. At 316, the virtualization server transmits, using the discovered IP address, a control channel connection request to the first application executed on the client device. At 318, the client device receives, at the first application, the control channel connection request. At 320 and 322, a control channel is established between the first and second applications based on the control channel connection request. At 324, the virtualization server transmits instructions from the second application to the first application via the control channel. At 326, the client device receives these instructions at the first application, and the first application is controlled remotely by the second application based on the instructions.

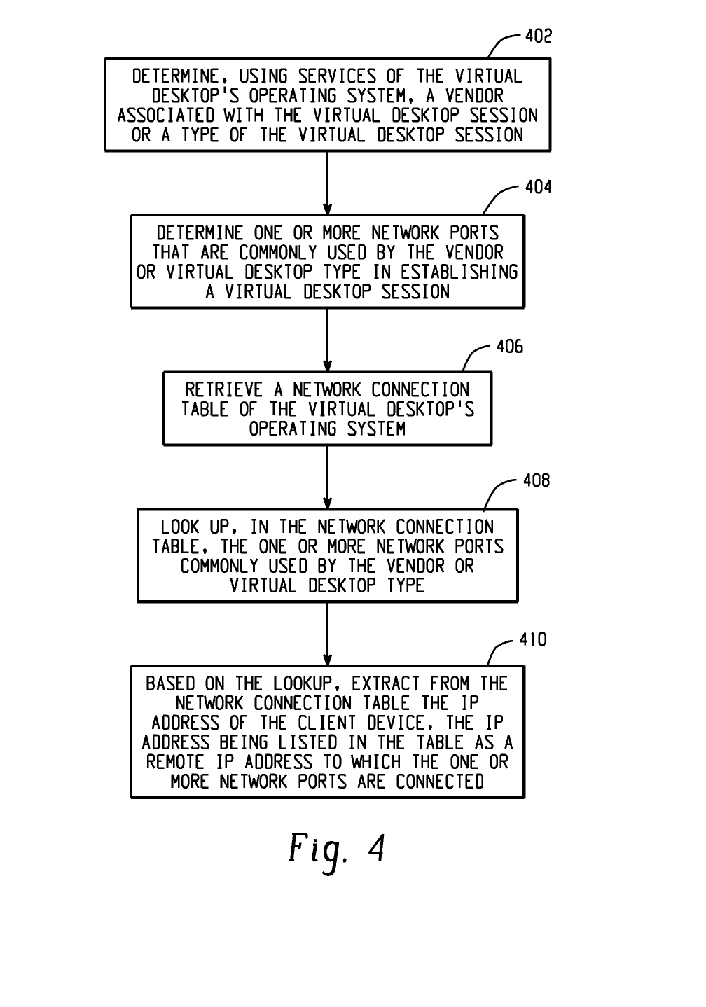

As described above, in the approaches described herein, a control channel between a first application executed on a client device and a second application executed on a virtualization server is established without the use of vendor-specific APIs. More specifically, the second application executed on the virtualization server is configured to run an algorithm to discover the IP address of the client device. The steps of the algorithm are not specific to a virtual desktop vendor or virtual desktop type and do not use vendor-specific APIs. In examples, the algorithm queries services (e.g., a process list, registry, installed application support directory, network connection table, etc.) of the local operating system executed on the virtualization server. Steps of an example algorithm performed by the second application to discover the IP address of the client device are illustrated in FIG. 4.

In FIG. 4, at 402, using services of the virtual desktop instance's operating system, a vendor associated with the virtual desktop session or a type of the virtual desktop session is determined. Such vendors or virtual desktop types include Citrix, VMWare, and Microsoft, among others. In examples, the determining of the vendor or virtual desktop type includes (i) retrieving a process list of the operating system, (ii) searching the process list for known process names, keywords, or text strings that are indicative of vendors or virtual desktop types, and (iii) determining the vendor or the virtual desktop type based on results of the searching. In examples, the determining of the vendor or virtual desktop type includes searching a registry or installed application support directories of the operating system for known process names, keywords, or text strings that are indicative of vendors or virtual desktop types, with the vendor or virtual desktop type being determined based on results of the searching.

At 404, one or more network ports that are commonly used by the vendor or virtual desktop type in establishing a virtual desktop session are determined. At 406, a network connection table of the operating system is retrieved, where the network connection table lists (i) network ports of the virtualization server, and (ii) remote IP addresses to which the network ports are connected. At 408, the one or more network ports commonly used by the vendor or virtual desktop type are looked up in the network connection table. At 410, based on the lookup, the IP address of the client device is extracted from the network connection table. The IP address is listed in the table as a remote IP address to which the one or more network ports are connected.

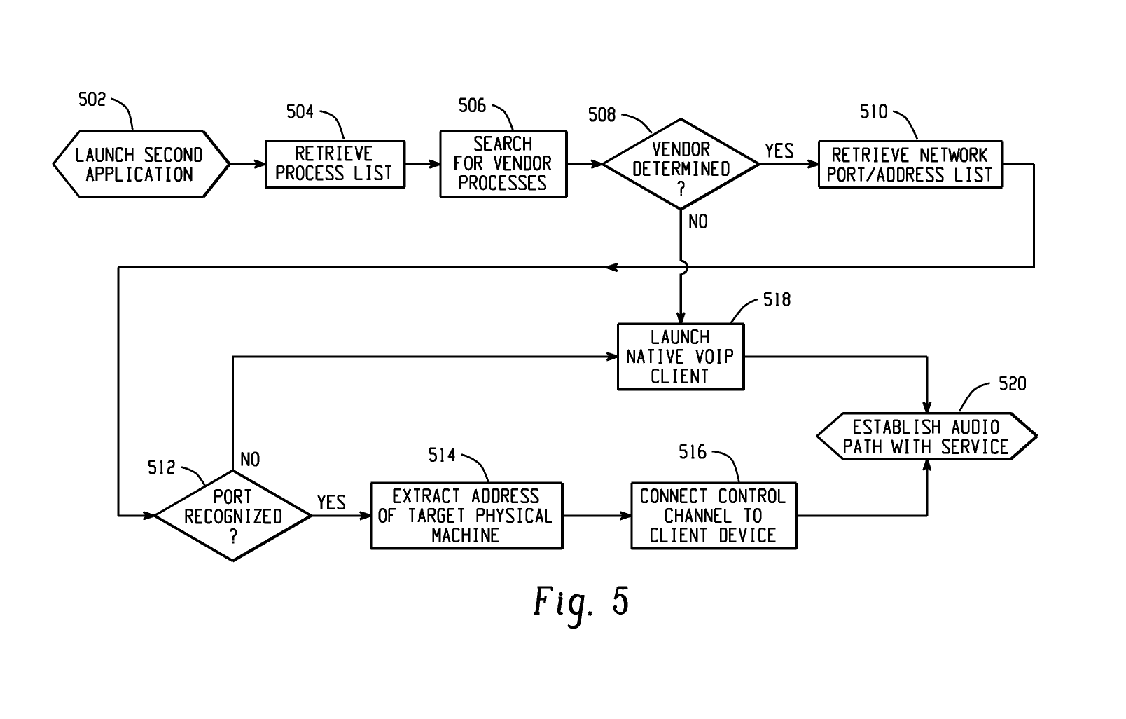

In examples, the second application determines that it is being executed in a virtual desktop environment prior to discovering the IP address of the client device. FIG. 5 illustrates example steps performed by the second application (i) to determine that it is running in a virtual desktop environment, and (ii) to determine the routing information necessary to connect the second application to the first application (e.g., media application) running on the client device where the virtual desktop is being accessed. In accessing a virtual desktop instance on the virtualization server, the client device initiates a connection to the virtualization server. Once this connection has been established, the client device connection information is recorded within the network connection tables of the operating system executed on the virtualization server. This recorded information may be retrieved according to the process described below and used in establishing the control channel between the first and second applications.

At 502, the second application is launched on the virtualization server. At 504, the second application retrieves a running process list of the local operating system of the virtualization server. Other services or information of the local operating system may be retrieved, such as the application support infrastructure (e.g., registry, installed application support directories). Each virtual desktop vendor has a unique pattern of processes, network ports, and application support infrastructure elements that are installed and running to support its virtualization engine execution. At 506, the process list and/or other services or information of the local operating system are examined and matched against a known set of process names, keywords, or application support elements to determine the vendor or virtual desktop type.

At 508, a determination is made as to whether the vendor or virtual desktop type was successfully determined. If the vendor or virtual desktop type was successfully determined, at 510, a network connection table (e.g., network routing map) of the local operating system of the virtualization server is retrieved. At 512, one or more network ports that are commonly used by the vendor or virtual desktop type are searched against the network connection table. If a port that is commonly used by the vendor or virtual desktop type is found in the network connection table, at 514, the IP address of the client device is extracted from the network connection table. At 518, a control channel is connected between the second application executed on the virtualization server and the first application (e.g., media application) executed on the client device.

If the vendor or virtual desktop type is not successfully determined at 508, or if the one or more ports associated with the vendor or virtual desktop type are not found in the network connection table at 512, the flowchart proceeds to step 518. At 518, a native Voice Over Internet Protocol (VOIP) client is launched at the client device. At 520, a media channel is established between the first application executed on the client device and a remote computing system. The establishment and use of the media channel are described in further detail below.

In examples, the control channel is used to enable an application executed on the virtualization server to remotely control a media application executed on the client device. To illustrate this example use of the control channel, reference is made to FIG. 6. This figure depicts a local workstation 602, which is an example of the client device described herein. The local workstation 602 executes a viewer application 604 and a media application 606. The media application 606 is an example of the “first application” described herein and is described in further detail below. FIG. 6 also depicts a virtualization server 616 that executes a virtual desktop instance 618. An application 620 executed within the virtual desktop instance 618 is an example of the “second application” described herein. The viewer application 604 is provided a view into the application 620 through an encrypted data channel 610 between the virtualization server 616 and the local workstation 602. The encrypted data channel 610 is formed as part of a virtual desktop session that is established between the systems 602, 616.

The local workstation 602 may instruct the virtualization server 616 to execute various applications within the virtual desktop instance 618. The local workstation 602 is provided a view into the execution and work product of the various applications through the encrypted data channel 610. For example, the local workstation 602 may instruct the virtualization server 616 to execute a word processing application or web browser application within the virtual desktop instance 618, and the local workstation 602 is provided a view into the executed application via the encrypted data channel 610. In this example, user inputs are transmitted from the local workstation 602 to the virtualization server 616 via the encrypted data channel 610 for controlling the word processing or web browser application. Likewise, virtual desktop display information showing results of the user inputs is transmitted from the virtualization server 616 to the local workstation 602 via the encrypted data channel 610.

For text-based applications, such as the aforementioned word processing application, the use of the encrypted data channel 610 in this manner may provide a relatively seamless user experience (e.g., the user may not be able to detect that the application is being executed on the virtualization server 616 and not locally on the local workstation 602). The encrypted data channel 610 is a tightly-controlled and secure environment and may work relatively well for asynchronous and non-real time applications. However, interacting with media applications (e.g., media applications utilizing one or more of audio, video, still images, and multimedia) using the encrypted data channel 610 may provide a less ideal user experience. The encrypted data channel 610 has high overhead and may introduce disruptions into the data stream. For media applications that require low latency and consistent bandwidth, packet ordering in this environment can introduce errors that degrade the effectiveness of the overall work product.

In the systems and methods described herein, the use of a control channel 612 and media channel 614 may eliminate or mitigate the aforementioned performance issues associated with media applications. Using the channels 612, 614, the user experience may be relatively seamless, such that the user cannot detect that the media application is executed remotely on the virtualization server 616 and not on the local workstation 602. As noted above, the control channel 612 is not based on vendor-specific APIs, and the approaches described herein are thus configured to operate with all virtual desktop solutions and are not specific to any virtual desktop vendor or virtual desktop type.

To provide the relatively seamless user experience, media is rendered on the local workstation 602, rather than the virtualization server 616. Thus, as shown in FIG. 6, the local workstation 602 executes the media application 606, which is configured to receive media from a remote computing system 624 via the media channel 614. In examples, the remote computing system 624 comprises a hosted service, as shown in FIG. 6. The remote computing system 624 may provide, for example, audio or video streams for rendering at the local workstation 602. As noted above, the media application 606 is an example of the “first application” described herein (e.g., the first application 260 of FIGS. 1 and 2) and is controlled remotely by the application 620, which is an example of the “second application” described herein (e.g., the second application 160 of FIGS. 1 and 2). The media application 606 is configured to render the media directly on the local workstation 602 using workstation media I/O 608. It is noted that the media channel 614 is formed directly between the media application 606 and the remote computing system 624, thus enabling media to be delivered directly from the remote computing system 624 to the media application 606 and without being routed through the virtualization server 616. As shown in the figure, the application 620 may communicate with the remote computing system 624 for various purposes, including application control 622 and media establishment control 623.

To provide the system shown in FIG. 6, the media application 606 is executed on the local workstation 602. The media application 606 waits for a connection from the application 620. When the application 620 is executed within the virtual desktop instance 618, it takes the necessary steps to determine that it is running in a virtual environment and determines the location (e.g., IP address) of the local workstation 602 where its associated media application 606 is waiting. The media application 606 is connected to the application 620 through the control channel 612, thus enabling the application 620 to remotely control the media application 606, as described above. Next, the media channel 614 is connected directly between the media application 606 and the remote computing system 624, thus enabling media to be delivered directly from the remote computing system 624 to the media application 606.

When a user connects to the virtual desktop instance 618 and executes the application 620, no further action by the user is necessary to establish the media channel 614 between the media application 606 and the remote computing system 624. To establish the media channel 614 automatically and without prompting by the user, the application 620 determines that it is running in a virtual desktop environment, as described above. The application 620 next discovers the routing needed to connect the control channel 612 to the media application 606 on the local workstation 602. As described herein, the network routing table of the virtual desktop instance 618 is interrogated to locate the address that is used to connect from the virtual desktop instance 618 to the viewer 604 running on the local workstation 602. In examples, this entry is identified by searching for “well known” ports used by virtualization server vendors for this purpose, as described above. This process provides the IP address of the local workstation 602 and can then be used to open the control channel 612 to the media application 606. The media application 606 can then be controlled remotely by the application 620. The control channel 612 is a secure IP connection between the media application 606 and the application 620.

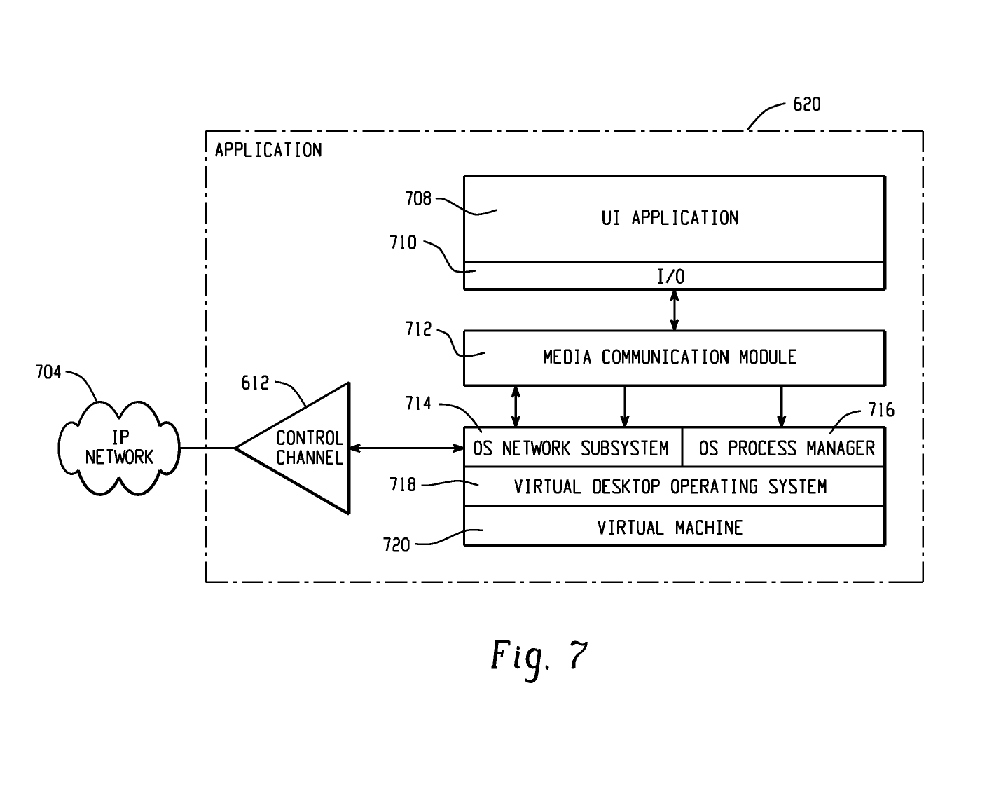

Features of the application 620 of FIG. 6 are illustrated in FIG. 7. As noted above, the application 620 is an example of the “second application” described herein (e.g., the second application 160 of FIGS. 1 and 2), which is executed on a virtualization server. A media communication module (MCM) 712 is the central coordinator of the media channel establishment process. The MCM 712 interacts with a user interface (UI) application 708 through an input/output (I/O) interface 710. The I/O interface 710 comprises a loosely-coupled API system, in an example. The I/O interface 710 enables the dynamic replacement of media communication modules such that the application 620 can leverage different media communication modules to establish the highest quality media channel 614 regardless of whether the application 620 is operating in a virtual desktop environment or a native desktop environment (i.e., a local desktop environment).

The MCM 712 is responsible for determining if the application 620 is operating in a virtual desktop environment (i.e., the MCM 712 is responsible for determining whether the application 620 is being executed in the context of a virtual machine, such as the virtual machine 720 of FIG. 7). Processes that may be performed by the MCM 712 in making this determination are described above with reference to FIGS. 4 and 5. If the virtual desktop environment is detected, then the MCM 712 dynamically loads the appropriate module and begins the control channel detection and establishment process. Exemplary steps that may be performed in the control channel detection and establishment process are described above with reference to FIGS. 3-5.

In examples, the MCM 712 communicates with the virtual desktop operating system 718 to collect the current running process list of the operating system 718. The MCM 712 may specifically communicate with the OS process manager 716 of the virtual desktop operating system 718 to collect the process list. The MCM 712 then inspects the process list for pre-determined qualities that identify the type of platform or virtual desktop vendor engine that is running. The inspection of the process list in this manner is described above with reference to FIGS. 4 and 5. Once the determination is made that the application 620 is running in a virtual desktop environment, the MCM 712 determines the IP address of the local workstation 602 where the media channel 614 is to be established.

The determination of the IP address of the local workstation 602 is described in detail above with reference to FIGS. 4 and 5. As noted above, the local workstation 602 initiated the connection to the virtualization server 616 in order to access the virtual desktop instance 618. Once this connection has been established, the connection information of the local workstation 602 is recorded within the network connection tables of the virtual desktop operating system 718. The MCM 712, knowing the virtual desktop vendor or virtual desktop type on which it is running, references the virtual desktop operating system's network connection table and locates the ports that the specific virtual desktop vendor or type uses when establishing its virtual desktop connection. The IP Address of the local workstation 602, which is associated with these ports within the network connection tables, is extracted. The IP Address of the local workstation 602 is then used to establish a control channel connection 612 to that local workstation 602 from the virtual desktop 618. To do this, the MCM 712 communicates with an OS network subsystem 714 to open the control channel connection 612 with the local workstation 602. The control channel 612 connects the application 620 and the media application 606 via a connection made over an IP network 704.

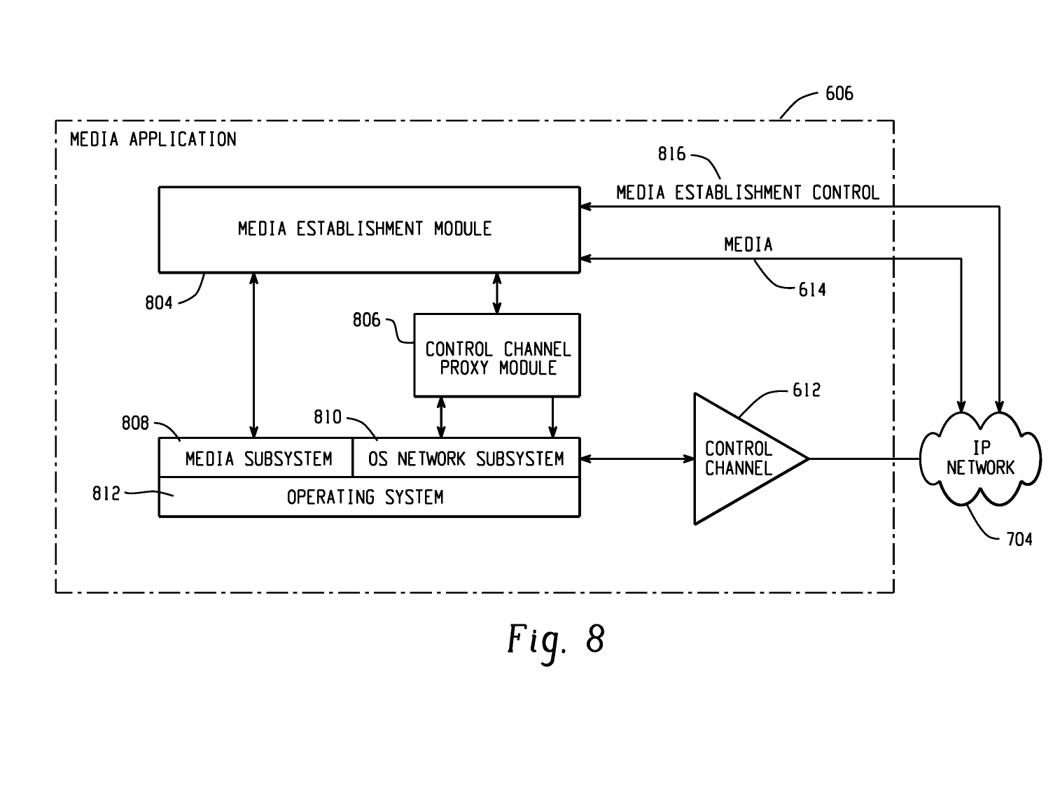

Features of the media application 606 of FIG. 6 are illustrated in FIG. 8. As noted above, the media application 606 is an example of the “first application” described herein (e.g., the first application 260 of FIGS. 1 and 2), which is executed on a client device. The media application 606 is installed and launched on the local workstation 602 prior to establishing a virtual desktop session with the virtualization server 616. When launched, the media application 606 opens a port and waits in the background until a control channel connection is requested from the virtual desktop instance 618. A control channel proxy module 806 controls the control channel connection system. Once a connection request is received at the media application 606 from the application 620, the control channel proxy module 806 completes the negotiation and connects the control channel 612. The control channel proxy module 806 may communicate with an OS network subsystem 810 in order to establish the control channel 612.

The control channel proxy module 806 then commands a media establishment module 804 to signal a media session connection to the remote computing system 624 through the IP network 704. The remote computing system 624 may be described herein as providing a “hosted service” and/or may comprise a “service network.” This is shown in FIG. 8 at media establishment control communications 816. Once the negotiation is complete, the media channel 614 is established between the remote computing system 624 and the local workstation 602. The establishment of the media channel 614 enables the media application 606 to receive media (e.g., audio streams, video streams, etc.) from the remote computing system 624, and the received media may be processed or manipulated by a media subsystem 808 of the media application 606. The media subsystem 808 and OS network subsystem 810 may comprise subsystems of an operating system 812. The media channel 614 connects the media application 606 and the remote computing system 624 via a connection made over the IP network 704.

The application 620 running in the virtual desktop instance 618 is notified through the control channel 612 that the media channel 614 has been established. The application 620 can then manage the operation and lifecycle of the media channel 614 through the control channel 612. In this manner, the application 620 remotely controls the media application 606 in order to manage the operation and lifecycle of the media channel 614. In examples, the operation of the media application 606 and the application 620, running on the two separate machines (e.g., the virtualization server 616 and the local workstation 602, respectively), is bound together, such that the applications 620, 606 operate and function in unison.

One of the primary uses of virtual desktop environments is to secure the information exchanged between the local workstation 602 and the remote computing system 624 (e.g., the service network). In order to maintain the security integrity of the communication session between these entities 602, 624, it is necessary to secure the control channel 612. Thus, encryption is used to protect the control channel 612 from being compromised over the IP network 704. In addition to encrypting the data channel itself, the login credentials used to access the remote computing system 624 are also protected. In examples, these credentials are not accessed or stored on the local workstation 602. Rather, these credentials exist only within the application 620 that is running fully contained within the virtual desktop instance 618.

In the systems and methods described herein, the identity of the user may be contained within the encrypted connections of the virtualized environment. The connection between the local workstation 602 and virtual desktop instance 618 (e.g., the connection comprising the encrypted data channel 610) is established without the need for the user to enter their credentials on the local workstation 602 itself, eliminating this as a possible security breach. The control channel 612 is encrypted and the encryption keys are managed centrally, without requiring manual intervention from the user. To maintain the security profile of the virtualized environment, the media channel 614 may be bound to the secure virtual desktop connection. In examples, the lifecycle of the media channel 614 that is associated with the secure virtual desktop session matches the user session lifecycle in order to maintain the security of the application session within the virtual desktop session. If the user were to log off of the virtual desktop session, the media channel 614 may also be disconnected, in examples. Likewise, if the virtual desktop session connection is interrupted, or a server action severs the virtual desktop session, the media channel 614 may detect this condition and disconnect itself from the remote computing system 624.

The media application 606 performs a continuous monitoring of the control channel connection 612 through both TCP/link layer and application layer mechanisms. If the application 620 running within the virtual desktop instance 618 initiates the disconnect, the media application 606 has the opportunity to disconnect gracefully under command of the application 620. If the control channel 612 disconnects from the media application 606, either due to a network or virtual desktop failure, the media application 606 must detect the condition and take independent action to resolve the issue. A re-connect sequence may be initiated to determine whether the interruption is temporary or permanent. If the control channel connection 612 is re-established within this process, the session may be re-authenticated and put back in service. If the control channel connection 612 does not get re-established, the media application 606 may gracefully disconnect the media channel 614. Once the media application 606 has disconnected from an application session, the media application 606 may immediately open a listen port and wait for the next control channel session to connect.

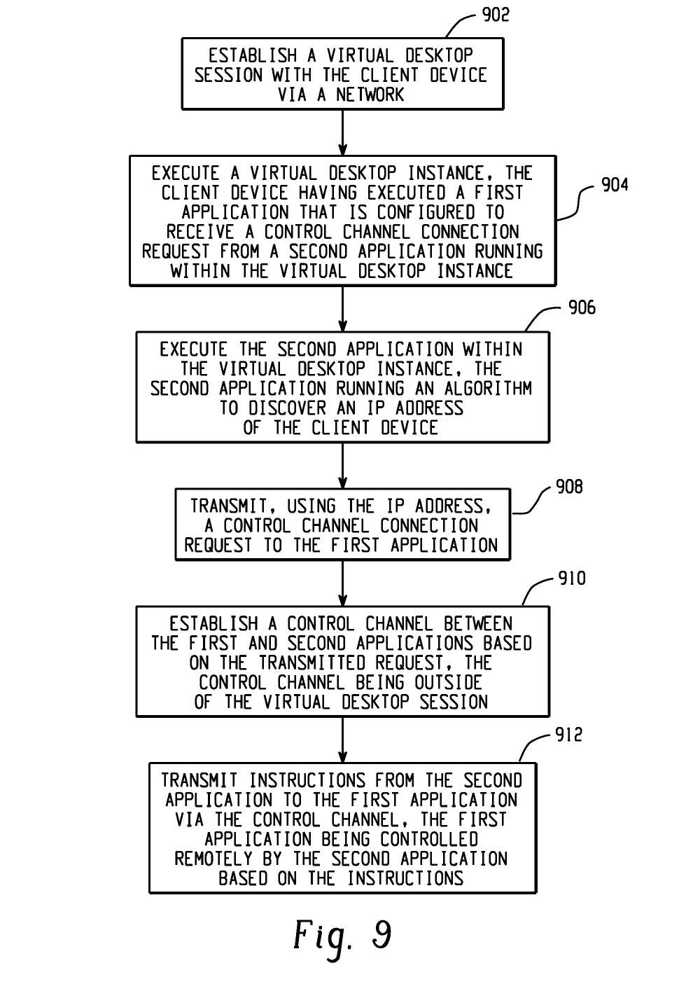

FIG. 9 is a flowchart depicting steps of an example computer-implemented method performed by a virtualization server for establishing a control channel between the virtualization server and a client device. At 902, a virtual desktop session with the client device is established via a network. At 904, a virtual desktop instance is executed, where the client device has executed a first application that is configured to receive a control channel connection request from a second application running within the virtual desktop instance. At 906, the second application is executed within the virtual desktop instance, where the second application runs an algorithm to discover an Internet Protocol (IP) address of the client device being used to access the second application. At 908, using the IP address, a control channel connection request is transmitted to the first application. At 910, a control channel is established between the first and second applications based on the transmitted request. The control channel is outside of the virtual desktop session. At 912, instructions are transmitted from the second application to the first application via the control channel, and the first application is controlled remotely by the second application based on the instructions.

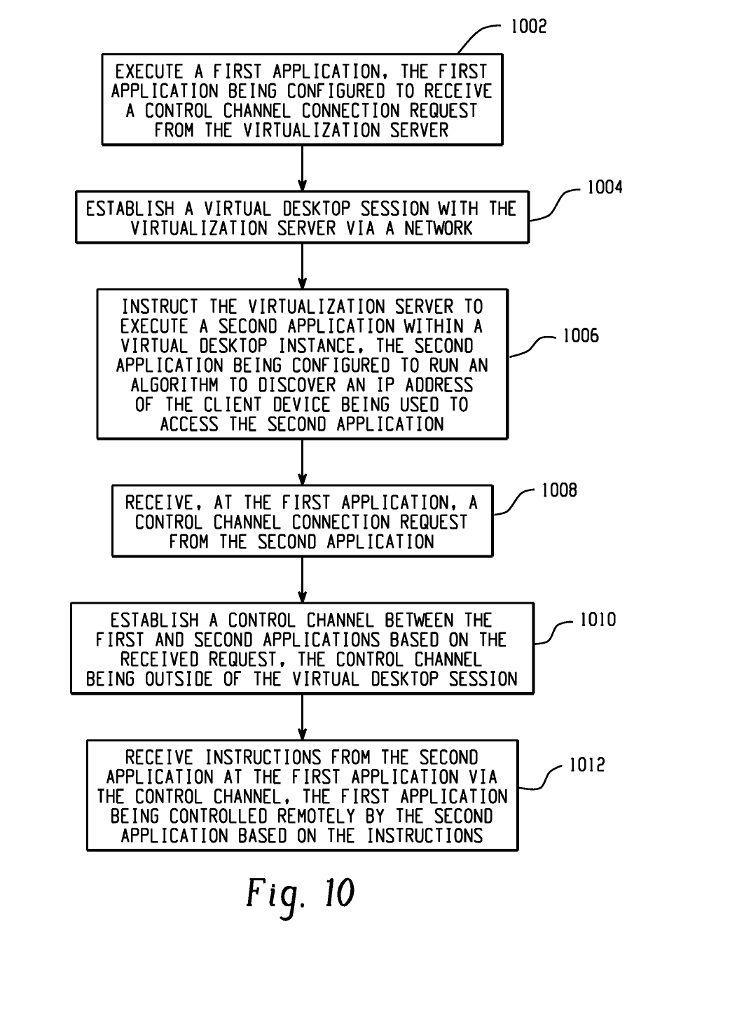

FIG. 10 is a flowchart depicting steps of an example computer-implemented method performed by a client device for establishing a control channel between the client device and a virtualization server. At 1002, a first application is executed, where the first application is configured to receive a control channel connection request from the virtualization server. At 1004, a virtual desktop session is established with the virtualization server via a network, the virtualization server executing a virtual desktop instance. At 1006, the virtualization server is instructed, via the virtual desktop session, to execute a second application within the virtual desktop instance. The second application is configured to (i) run an algorithm to discover an Internet Protocol (IP) address of the client device being used to access the second application, and (ii) transmit, using the IP address, a control channel connection request to the first application. At 1008, the control channel connection request is received at the first application. At 1010, a control channel is established between the first and second applications based on the received request, where the control channel is outside of the virtual desktop session. At 1012, instructions are received from the second application at the first application via the control channel, and the first application is controlled remotely by the second application based on the instructions.

This written description uses examples to disclose the invention, including the best mode, and also to enable a person skilled in the art to make and use the invention. The patentable scope of the invention includes other examples. Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Further, as used in the description herein and throughout the claims that follow, the meaning of “each” does not require “each and every” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive of” may be used to indicate situations where only the disjunctive meaning may apply.

It is claimed:

1. A computer-implemented method performed by a virtualization server for establishing a control channel between the virtualization server and a client device, the method comprising:
establishing a virtual desktop session with the client device via a network;
executing a virtual desktop instance, the client device having executed a first application that is configured to receive a control channel connection request from a second application running within the virtual desktop instance;
executing the second application within the virtual desktop instance, the second application running an algorithm to discover an Internet Protocol (IP) address of the client device being used to access the second application;
transmitting, using the IP address, a control channel connection request to the first application;
establishing a control channel between the first and second applications based on the transmitted request, the control channel being outside of the virtual desktop session; and
transmitting instructions from the second application to the first application via the control channel, the first application being controlled remotely by the second application based on the instructions.

2. The method of claim 1, wherein the virtual desktop instance comprises an operating system, and wherein the algorithm is configured to discover the IP address of the client device based on one or more services of the operating system.

3. The method of claim 2, wherein the one or more services of the operating system comprise a process list, registry, installed application support directory, or network connection table.

4. The method of claim 2, wherein the discovering of the IP address of the client device comprises:
determining, using the one or more services of the operating system, a vendor associated with the virtual desktop session or a type of the virtual desktop session;
determining one or more network ports that are commonly used by the vendor or virtual desktop type in establishing a virtual desktop session;
retrieving a network connection table of the operating system, the network connection table listing (i) network ports of the virtualization server, and (ii) remote IP addresses to which the network ports are connected;
looking up, in the network connection table, the one or more network ports commonly used by the vendor or virtual desktop type; and
based on the lookup, extracting from the network connection table the IP address of the client device, the IP address being listed in the table as a remote IP address to which the one or more network ports are connected.

5. The method of claim 4, wherein the determining of the vendor or the virtual desktop type comprises:
retrieving a process list of the operating system;
searching the process list for known process names, keywords, or text strings that are indicative of vendors or virtual desktop types; and
determining the vendor or the virtual desktop type based on results of the searching.

6. The method of claim 4, wherein the determining of the vendor or the virtual desktop type comprises:
searching a registry or installed application support directories of the operating system for known process names, keywords, or text strings that are indicative of vendors or virtual desktop types; and
determining the vendor or the virtual desktop type based on results of the searching.

7. The method of claim 1, wherein the discovering of the IP address and the establishing of the control channel do not comprise steps that are specific to a virtual desktop vendor or virtual desktop type.

8. The method of claim 1, wherein the virtual desktop instance comprises one or more application programming interfaces (APIs) that are specific to a virtual desktop vendor or virtual desktop type, and wherein the one or more APIs are (i) not utilized in determining the IP address, and (ii) not used in establishing the control channel.

9. The method of claim 1, wherein the control channel connects the first and second applications via a connection made over an IP network.

10. The method of claim 1 comprising:
receiving, via the control channel, an indication from the first application that a media channel has been established between the first application and a remote computing system, the media channel being outside of the virtual desktop session and enabling media to be transmitted between the remote computing system and the first application (i) without being routed through the virtualization server, and (ii) without being routed through the control channel.

11. The method of claim 10, wherein the instructions control an operation or life cycle of the media channel.

12. The method of claim 10, wherein the media channel connects the first application and the remote computing system via a connection made over an IP network.

13. The method of claim 1, wherein the second application is configured to:
determine whether the second application is being executed in a virtual desktop environment; and
based on a determination that the second application is being executed in the virtual desktop environment, determine the IP address of the client device.

14. The method of claim 13, wherein the determining of whether the second application is being executed in a virtual desktop environment comprises:
querying one or more services of the virtual desktop instance's operating system for known process names, keywords, or text strings that are indicative of a virtual desktop environment; and
determining whether the second application is being executed in a virtual desktop environment based on results of the querying.

15. A virtualization server that hosts a virtual desktop that is configured to establish a control channel between the virtualization server and a client device, the virtualization server comprising:
a processing system; and
a memory coupled to the processing system, wherein the processing system is configured to execute steps comprising:
establishing a virtual desktop session with the client device via a network;
executing a virtual desktop instance, the client device having executed a first application that is configured to receive a control channel connection request from a second application running within the virtual desktop instance;
executing the second application within the virtual desktop instance, the second application running an algorithm to discover an Internet Protocol (IP) address of the client device being used to access the second application;
transmitting, using the IP address, a control channel connection request to the first application;
establishing a control channel between the first and second applications based on the transmitted request, the control channel being outside of the virtual desktop session; and
transmitting instructions from the second application to the first application via the control channel, the first application being controlled remotely by the second application based on the instructions.

16. An article of manufacture comprising a non-transitory computer readable storage medium having computer program instructions for establishing a control channel between a virtualization server and a client device, said instructions when executed adapted to cause a processing system to execute steps comprising:
establishing a virtual desktop session with the client device via a network;
executing a virtual desktop instance, the client device having executed a first application that is configured to receive a control channel connection request from a second application running within the virtual desktop instance;
executing the second application within the virtual desktop instance, the second application running an algorithm to discover an Internet Protocol (IP) address of the client device being used to access the second application;
transmitting, using the IP address, a control channel connection request to the first application;
establishing a control channel between the first and second applications based on the transmitted request, the control channel being outside of the virtual desktop session; and
transmitting instructions from the second application to the first application via the control channel, the first application being controlled remotely by the second application based on the instructions.

17. A computer-implemented method performed by a client device for establishing a control channel between the client device and a virtualization server, the method comprising:
executing a first application, the first application being configured to receive a control channel connection request from the virtualization server;
establishing a virtual desktop session with the virtualization server via a network, the virtualization server executing a virtual desktop instance;
instructing, via the virtual desktop session, the virtualization server to execute a second application within the virtual desktop instance, the second application being configured to (i) run an algorithm to discover an Internet Protocol (IP) address of the client device being used to access the second application, and (ii) transmit, using the IP address, a control channel connection request to the first application;
receiving, at the first application, the control channel connection request;
establishing a control channel between the first and second applications based on the received request, the control channel being outside of the virtual desktop session; and
receiving instructions from the second application at the first application via the control channel, the first application being controlled remotely by the second application based on the instructions.

18. The method of claim 17, wherein the virtual desktop instance comprises an operating system, and wherein the algorithm is configured to discover the IP address of the client device based on one or more services of the operating system.

19. The method of claim 17, wherein the control channel connects the first and second applications via a connection made over an IP network.

20. The method of claim 17 comprising:
after establishing the control channel, establishing a media channel between the first application and a remote computing system, the media channel being outside of the virtual desktop session and enabling media to be transmitted between the remote computing system and the first application (i) without being routed through the virtualization server, and (ii) without being routed through the control channel; and
transmitting to the second application an indication that the media channel has been established, the indication being transmitted over the control channel.

21. The method of claim 20, wherein the first application is configured to receive media from the remote computing system and to render the media at the client device.

22. The method of claim 20, wherein the instructions received from the second application via the control channel control an operation or life cycle of the media channel.

23. The method of claim 20, wherein the media channel connects the first application and the remote computing system via a connection made over an IP network.

24. The method of claim 18, wherein the one or more services of the operating system comprise a process list, registry, installed application support directory, or network connection table.

25. The method of claim 17, wherein the discovering of the IP address and the establishing of the control channel do not comprise steps that are specific to a virtual desktop vendor or virtual desktop type.

26. The method of claim 17, wherein the virtual desktop instance comprises one or more application programming interfaces (APIs) that are specific to a virtual desktop vendor or virtual desktop type, and wherein the one or more APIs are (i) not utilized in determining the IP address, and (ii) not used in establishing the control channel.

27. A client device configured to establish a control channel between the client device and a virtualization server, the client device comprising:
a processing system; and
a memory coupled to the processing system, wherein the processing system is configured to execute steps comprising:
executing a first application, the first application being configured to receive a control channel connection request from the virtualization server;
establishing a virtual desktop session with the virtualization server via a network, the virtualization server executing a virtual desktop instance;
instructing, via the virtual desktop session, the virtualization server to execute a second application within the virtual desktop instance, the second application being configured to (i) run an algorithm to discover an Internet Protocol (IP) address of the client device being used to access the second application, and (ii) transmit, using the IP address, a control channel connection request to the first application;
receiving, at the first application, the control channel connection request;
establishing a control channel between the first and second applications based on the received request, the control channel being outside of the virtual desktop session; and
receiving instructions from the second application at the first application via the control channel, the first application being controlled remotely by the second application based on the instructions.

28. An article of manufacture comprising a non-transitory computer readable storage medium having computer program instructions for establishing a control channel between a virtualization server and a client device, said instructions when executed adapted to cause a processing system to execute steps comprising:
executing a first application, the first application being configured to receive a control channel connection request from the virtualization server;
establishing a virtual desktop session with the virtualization server via a network, the virtualization server executing a virtual desktop instance;
instructing, via the virtual desktop session, the virtualization server to execute a second application within the virtual desktop instance, the second application being configured to (i) run an algorithm to discover an Internet Protocol (IP) address of the client device being used to access the second application, and (ii) transmit, using the IP address, a control channel connection request to the first application;
receiving, at the first application, the control channel connection request;
establishing a control channel between the first and second applications based on the received request, the control channel being outside of the virtual desktop session; and
receiving instructions from the second application at the first application via the control channel, the first application being controlled remotely by the second application based on the instructions.
